(19) United States
(12) Patent Application Publication
(10) Pub. No.: US 2024/0169438 A1
(43) Pub. Date: May 23, 2024

(54) API-DRIVEN INTERNET FINANCIAL SERVICES SYSTEM AND METHODS

(71) Applicant: APITURE, INC., WILMINGTON, NC (US)

(72) Inventor: David James Biesack, Fuquay-Varina, NC (US)

(21) Appl. No.: 18/511,049

(22) Filed: Nov. 16, 2023

Related U.S. Application Data
(60) Provisional application No. 63/426,134, filed on Nov. 17, 2022.

(51) Int. Cl. G06Q 40/06; G06F 9/54

(52) U.S. Cl. CPC G06Q 40/06; G06F 9/547

(57) ABSTRACT

API-driven internet financial services systems are provided. Exemplary systems include an application web service. The application web service includes an application program interface (API) service wherein the API service includes workflow items such as at least one workflow characterized by a workflow definition, and at least one workflow task characterized by a workflow task definition. All workflows include at least one workflow tasks. The workflow items follow JSON and JSON schema, and software embodied in the workflow items, residing in the API service, can be executed to accomplish financial transaction processing without the need for marshalling said code into API-friendly formats, thus allowing a flexible, financial institution-customizable internet financial services platform. Exemplary systems may be embodied in non-transitory computer-readable storage mediums including instructions for implementing the systems.

### CROSS REFERENCE TO RELATED APPLICATIONS

This application claims the benefit of priority of U.S. Provisional Application Ser. No. 63/426,134, filed on Nov. 17, 2022, which is incorporated herein in its entirety.

### FIELD

The present invention relates to a system for internet financial services and, more particularly, to a system for providing internet financial services using an API-driven approach.

### BACKGROUND OF THE INVENTION

The field of internet financial services, i.e., services that enable financial transactions, bill payments, loan or bank account origination, asset management, related intermediate steps including payment processing, and the like over the internet through a financial or other institution's secure website or application, is now a large industry with continued growth and diversification. Ease of use and convenience contribute to this continued rapid growth over traditional financial services. Internet or online financial services allow customers to satisfy their financial services needs anytime and anywhere that internet access is available, even when “brick and mortar” financial institution branches or corporate offices are closed, financial advisors or agents are unavailable, or an in-person transaction is otherwise difficult or inconvenient. In most cases, no special hardware or software is needed; all that is required is a web browser (such as Microsoft Edge) or an application and an internet connection.

Financial services in general, and internet or online financial services in particular, are the subject of complex and frequently changing regulations. Such regulations include those that address privacy and cybersecurity owed to customers, consumers, or other market participants in transfer of business, consumer financial and personal information, financial institution-specific regulations like requirements for maintaining separation of certain kinds of assets and operations, regulations for anti-fraud efforts, regulations for anti-terrorism efforts, and others. Appropriately addressing this regulatory landscape while maintaining user and operator convenience and ease of use can present internet financial service providers with a great challenge, both in designing, and in maintaining systems. Customers further demand more and more financial services features as online financial services markets continue to grow, and each new feature must comply with this complex regulatory backdrop.

Internet financial services systems must necessarily integrate with and rely on the use of Application Programming Interfaces (APIs) as part of online financial service delivery through web-based software services. APIs allow application developers to reuse web-based software services through invocation of web service requests and processing of the responses. Modern APIs use the Representational State Transfer (REST) architectural style and JavaScript Object Notation (JSON) format (such APIs are described with JSON Schema) for exchanging data between a client and a web service. APIs improve flexibility and functionality in providing services to customers.

APIs as they are conventionally used in the provision of online financial services act as an intermediary between a customer or end user and financial institution software functions. Conventional software systems for providing internet financial services (mobile banking, loan origination, equity trading, payment processing, other business processes, etc.), however, did not evolve in parallel with the development of APIs, and so these conventional systems are not API-centric on the financial institution software function side. Such systems, because they have largely been developed by or directly on behalf of financial institutions, tend to be reliant on financial institution source code programming and written in programming language that is idiosyncratic to specific institutions, tailored to back-end services and limitations (those of the financial institutions or their service providers), without providing for smooth integration into the API environment.

This approach can be extremely cumbersome in its integration with other service providers or in use by customers through the use of APIs with web-based software services. Integration of conventional systems with APIs requires significant marshalling of idiosyncratic financial institution code for API compatibility. Marshalling of institution code adds cost by requiring development time and attention and, because it inherently involves changes to product/service software, such marshalling also adds cost through an increased risk of introduction of errors that may negatively impact product function and consumer experience. These costs and problems are compounded by the ever-changing nature of financial regulations and the attendant need to update and modify software and related code to meet such changes, again, all in a manner that provides for customer convenience and ease of use. Such costs and problems can similarly hamper development of new features and services.

Thus, conventional internet financial services systems are minimally interoperative with API-based systems and can be very difficult to maintain in compliance with regulation while also providing an effective user/customer experience.

In view of the foregoing, the present invention relates to an improvement upon the known systems and methods for providing internet financial services, and provides distinct advantages over the conventional systems and methods.

### BRIEF SUMMARY OF THE INVENTION

An API-driven internet financial services system is disclosed. As revealed in the following description and the figures herein, this disclosure provides a system, method, and non-transitory computer-readable storage medium for providing financial services systems as RESTful resources that integrate well with the existing API environment. This API service invention allows a revisions of workflow items without changing the code. The software code embodied in workflow items, residing in the API service, may be executed to accomplish financial transaction processing without the need for marshaling said code into API-friendly formats, thus allowing a flexible, financial institution-customizable internet financial services platform.

In accordance with certain aspects of certain embodiments of the present technology, an institution-customizable internet financial services system may comprise a host site, which the host site comprises an application web service. The application web service comprises an application programming interface (API) service wherein the API service comprises workflow items. The workflow items may include at least one workflow characterized by a workflow definition, and at least one workflow task characterized by a workflow task definition, and all workflows include at least one workflow task. The workflow items follow JavaScript Object Notation (JSON) JSON and JSON schema, and cause the system to receive the workflow input selection and a workflow task input selection from an interface. The system identifies the workflow definition associated with the workflow selection and the workflow task definition associated with the workflow task; retrieves an execution sequence graph template according to the workflow definition and an execution sequence graph template according to the workflow task definition; and revises a workflow initial execution state and a workflow task initial execution state. When revising a section of workflow, the API service system calls on saved workflow definitions and saved workflow task definitions in the API environment, and therefore a code for the workflow definition and a code for the workflow definition does not need to be marshaled into API-friendly formats during the revising. Additionally and/or alternatively, in various embodiments one or more of the following features may also be included:
(a) the host site further may include an API gateway and an API;
(b) a database server may include an internet financial services database;
(c) each workflow definition includes a dependency and execution sequence graph including workflow tasks, wherein execution of the workflow tasks is coordinated according to the workflow definition as provided in the dependency and execution sequence graph;
(d) the workflow items use a uniform representation comprising an execution state, a set of local data described by JSON schema, and an interface;
(e) the workflow item interface defines a set of inputs and outputs consisting of a subset of the local data;
(f) any workflow task, its interface and local data, or derivatives thereof, can be saved as a new workflow task definition and any workflow, its interface and local data, or derivatives thereof, can be saved as a new workflow definition;
(g) each workflow definition includes a dependency and execution sequence graph and wherein the dependency and execution sequence graph of each workflow definition comprises workflow tasks connected to one another by their respective inputs and outputs in a designated sequence;
(h) at least one workflow task supports calling a REST API that is external to the host site or is co-located with the API service in the host site;
(i) the workflow item definitions are immutable and may be included in new or other workflow items by reference;
(j) the workflow items are embedded in new or other workflow items as hypermedia controls with a link representing a relationship from the new or other workflow item to the referenced workflow item;
(k) the workflow items are persistent;
(l) each workflow definition and workflow task definition is immutable to a system manager and instead of being edited or updated, workflow definitions and workflow task definitions are changed by creating new revisions that contain changes, said new revisions can be referenced in a workflow item by a workflow item title containing a name of the workflow item and revision identifier, or a workflow item can reference the latest revision of a workflow by referencing only a name of the workflow item, absent a revision identifier;
(m) an end user accesses the internet financial services system to conduct an internet financial services transaction by connecting to the host site and API service using a browser from a remote client;
(n) the workflow tasks perform high-level business (financial services, e.g., banking) processes including, for example, identity verification, uploading documents, requesting new account, filling in form, approving a document, and approving an account application;
(o) a link between the remote site and the host site is secured through the use of Hypertext Transfer Protocol or a virtual private network;
(p) the workflow tasks further may include a restartable attribute that determines, according to execution by an execution engine of a workflow containing the workflow task, whether the workflow task may be restarted or not;
(q) at least one workflow task further includes a data conversion expression allowing transformation of input data of the task as opposed to in a separate transformation step in the corresponding workflow;
(r) the API-driven internet financial services system may allow an end user to remotely perform a financial transaction including remotely opening a new bank account; and/or
(s) the remote site is selected from the group that may include a personal computer and/or a mobile device including a mobile phone or tablet.

In accordance with additional aspects of other embodiments of the present technology, a computer-implemented method may perform internet financial services with a financial institution-customizable internet financial services platform, and may comprise providing an application program interface (API) service. The API service resides in an application web service that may be accessed through a network to allow-communication between an end user and a financial services institution via the API service, and the API service resides in an application web service that may be accessed through a network. The API service may include workflow items that may include at least one workflow and at least one workflow task, and wherein all workflows include at least one workflow task. The API service may receive at least one workflow selection is characterized by a workflow definition, and at least one workflow task selection is characterized by a workflow task definition and wherein all workflows include at least one workflow task; the workflow items follow JavaScript Object Notation (JSON) and JSON schema. The API service may identify the workflow definition associated with the workflow selection and the workflow task definition associated with the workflow task; retrieve an execution sequence graph template according to the workflow definition and an execution sequence graph template according to the workflow task definition; and revise a workflow initial execution state and a workflow task initial execution state. When revising a section of workflow, saved workflow definitions and saved workflow task definitions in the API environment may be called on. Therefore, a code for the workflow definition and a code for the workflow definition does not need to be marshaled into API-friendly formats during the revising. Additionally and/or alternatively, in various embodiments one or more of the following features may also be included:
(a) using a uniform representation for the workflow items comprising an execution state, a set of local data, and an interface;
(b) defining a set of inputs and outputs that are each a subset of the local data, and the inputs and outputs are each defined according to JavaScript Object Notation (JSON) and JSON schema;
(c) saving any workflow item and local data as a new workflow item definition, wherein the workflow item definitions are immutable and may be included in new or other workflow items by reference;
(d) at least one workflow task supports calling a REST API that is external to the application web service;
(e) performing high-level business (financial services) processes; and/or
(f) each workflow item is immutable and instead of being edited or updated, changing workflow items by creating new revisions that contain changes, said revisions referenced in a workflow item by a workflow item title containing a name of the workflow item and revision reference number, or a client can reference the latest revision of a workflow by referencing only the name of the workflow item, absent a revision reference number.

In accordance with still further aspects of other embodiments of the present technology, a non-transitory computer-readable storage medium comprising instructions, wherein the instructions cause a processor to perform the steps comprising: accessing an application programming interface API service, the API service residing in an application web service that may be accessed through a network to allow communication between an end user and a financial services institution via the API service. The API service comprises workflow items comprise at least one workflow and at least one workflow task, and wherein all workflows include at least one workflow task. The at least one workflow is characterized by a workflow definition, and the at least one workflow task is characterized by a workflow task definition. The workflow items follow JavaScript Object Notation (JSON) and JSON schema. The steps continue with receiving a workflow input selection and a workflow task input selection from an interface; identifying the workflow definition associated with the workflow selection and the workflow task definition associated with the workflow task; retrieving an execution sequence graph template according to the workflow definition and an execution sequence graph template according to the workflow task definition; and revising a workflow initial execution state and a workflow task initial execution state. When revising a section of workflow, saved workflow definitions and saved workflow task definitions in the API environment will be called on; thereby, a code for the workflow definition and a code for the workflow definition does not need to be marshaled into API-friendly formats during the revising. Additionally and/or alternatively, in various embodiments one or more of the following features may also be included:
(a) using a uniform representation for the workflow items comprising an execution state, a set of local data, and an interface;
(b) defining a set of inputs and outputs that are each a subset of the local data, and the inputs and outputs are each defined according to JSON and JSON schema;
(c) saving any workflow item and its interface and local data as a new workflow item definition and the workflow item definitions are immutable and may be included in new or other workflow items by reference;
(d) at least one workflow task supports calling a REST API that is external to the application web service;
(e) the workflow tasks performing high-level business (financial services) processes; and/or
(f) each workflow item is immutable and instead of being edited or updated, workflow items are changed by creating new revisions that contain changes, said revisions can be referenced in a workflow item by a workflow item title containing a name of the workflow item and revision reference number, or a client can reference the latest revision of a workflow item by referencing only the name of the workflow item, absent a revision reference number.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

The purpose of the Abstract hereinabove is to enable the United States Patent and Trademark Office, and the public generally, to determine quickly from a cursory inspection the nature of the technical disclosure. The Abstract is not provided for interpreting the scope of the claims herein, nor to define the invention or the application, nor to be limiting in any way as to the scope of the invention.

### BRIEF DESCRIPTION OF THE DRAWINGS

The details of the present invention, as to both its structure and its operation, can be understood with reference to the accompanying drawings, in which:

FIG. 1 is a block diagram of a system according to an exemplary embodiment;

FIG. 2A depicts a flow diagram of a dependency and execution sequence graph for a workflow definition in accordance with an exemplary embodiment;

FIG. 2B depicts a dependencies array in accordance with an exemplary embodiment;

FIG. 2C depicts a flow diagram of a dependency and execution sequence graph with descriptions of inputs, outputs, and data values for a workflow in accordance with an exemplary embodiment; and

FIG. 2D depicts a flow diagram of an excerpt from a dependency and execution sequence graph with descriptions of inputs, outputs, and data values for a workflow task in accordance with an exemplary embodiment.

### DETAILED DESCRIPTION

Reference will now be made in detail to the presently preferred embodiments of the invention, one or more examples of which are illustrated in the drawings. Each example is provided by way of explanation of the invention, and is not meant as a limitation of the invention. For example, features illustrated or described as part of one embodiment may be used with a second embodiment to yield a third embodiment. It is intended that the present application include such modifications and variations as come within the scope and spirit of the invention. Repeat use of reference characters throughout the present specification and appended drawings is intended to represent the same or analogous features or elements of the invention.

Before any embodiments of the invention are explained in detail, it is to be understood that the invention is not limited in its application to the details of construction or to the arrangement of components set forth in the following description or illustrated in the drawings. The invention is capable of other embodiments and of being practiced or of being carried out in various ways. Also, it is to be understood that the phraseology used herein is for the purpose of description and should not be regarded as limiting. The use of formatives of the words “include,” “comprise,” and “have” is meant to encompass the items listed thereafter and equivalents thereof, as well as additional items.

An “Application Programming Interface” or “API” refers to a software interface that defines a protocol or contract that dictates the form of communication between a computer program and an API Service. APIs define web-based data and processing requests sent to an API service from a client, for example, mobile applications or web browsers, and the form of the data the clients receive from the API service in response to those requests.

An “API service” refers to an API-based software service that connects a computer program to a programming library. An API service implements an API contract to receive requests from a client, for example, mobile applications or web browsers, process the requests, and return responses to the client.

The term “end user,” as used herein, means a consumer or other customer who avails themself of financial services (i.e., an entity that interacts with the disclosed API-driven internet financial services system for receipt of financial services).

“JavaScript object notation” or “JSON” or data described according to “JSON schema” refers to a defined data interchange format. REST API calls receive data encoded in JSON and return the results of a call encoded in JSON. JSON is an open standard data-interchange format that uses human-readable text to transmit data objects including attribute-value pairs and ordered lists of values. JSON is used primarily to transmit data between a server and a web application or between a server and another remote service and as an alternative to XML. JSON is a language-independent data format, and is easy for machines to parse and generate.

The term “remote” as used herein with respect to an end user or a client (for instance, a web, desktop, or mobile app), means that the end user or client is separate from an internet financial services database where data is housed (for instance, in a database supported by cloud service providers). In this way, a remote end user or a remote client need not enter the “brick and mortar” branches or directly interface with corporate offices and service providers therein traditionally used to physically provide financial services.

“Representational State Transfer” or “REST” is a software architecture style characterized by guidelines for creating scalable internet or web services. REST is a set of constraints applied to the design of components of the internet or web services. REST is recognized as a simpler alternative to the Simple Object Access Protocol (“SOAP”) and to Web Services Description Language (“WSDL”)-based web services. RESTful systems use hypertext transfer protocol (HTTP) and the same HTTP verbs (GET, POST, PATCH, PUT, DELETE, etc.) used by web browsers to retrieve web pages and send data.

REST APIs are network APIs that organizations publish to allow various clients, for example, mobile applications or web browsers, to integrate with the organizations' software services and content. A REST API call includes an HTTP verb, a uniform resource locator (URL) of a resource, an optional request body (data or content to pass to the API), and HTTP headers that provide options or parameters for the API call. The REST API call returns an integer HTTP status code, an optional response body that includes the content of the request result, and optional response HTTP headers that describe the response.

A “system manager,” as used herein, means a person or entity who manages and may make changes to or compose workflow items and workflow item definitions, as defined herein, in an API-driven internet financial services system for access, display, and interaction with by end users in a client application. A system manager may be, for example, a representative of a financial institution, who manages the API-driven internet financial services system for the financial institution so that the internet financial services system may be provided to the financial institution's customers. Said system manager may also be an artificial intelligence.

A “workflow” is a software-based business or financial process that may be part or all of a software-based financial service. Such a process is expressed as steps and each step executes a workflow task, as defined herein, according to a workflow definition, as also defined herein. A workflow refers to an instance of a workflow definition.

A “workflow definition” is a set of workflow tasks arranged and connected according to a dependency and execution sequence graph. A specific workflow may be executed by operation of an execution engine to accomplish a series of tasks according to the workflow's workflow definition. Connections between workflow tasks in a workflow definition may have simple or complex business rules attached.

A “workflow item” is an umbrella term that consists of workflows and workflow tasks, as defined herein.

A “workflow task” refers to a standalone business or financial operation that accomplishes a high level business or financial process (e.g., identity verification, upload documents, request new account, fill in form, approve a document, approve an account application, etc.). Each workflow task can have a unique visual representation to aid in understanding. A workflow task refers to an instance of a workflow task definition, as defined herein.

A “workflow task definition” is a set of instructions that together accomplish a business or financial operation on input data, yielding an output that may or may not be the same and may or may not be in the same format as the input data.

A “workflow item definition” is an umbrella term that consists of workflow definitions and workflow task definitions.

An API-driven internet financial services system for providing API-driven internet financial services is disclosed. This disclosure provides a notation, system, and method for providing financial services systems as RESTful resources that integrate well with the existing API environment for internet financial services relative to conventional systems, which require significant and costly code marshalling for any updates in order translate idiosyncratic financial institution software services to API-friendly formats. Workflow items of the inventive financial services systems are managed as resources (data) instead of as source code, allowing financial institutions and administrators to change system workflows or add new workflows dynamically, without the need for source code programming, code marshalling, or new software updates or deployments.

According to an exemplary embodiment, the internet financial services system includes an API service. The API service includes workflow items including: at least one workflow characterized by a workflow definition, and at least one workflow task characterized by a workflow task definition, wherein all workflows include at least one workflow task. Preferably, each of the workflow items are defined according to JSON and JSON schema. Code embodied in the workflow items, residing in the API service, accomplishes financial transaction processing in integration with APIs external to the API service and a financial institution database without the need for marshalling of said code into external API-friendly formats, thus allowing a flexible, financial institution-customizable internet financial services platform.

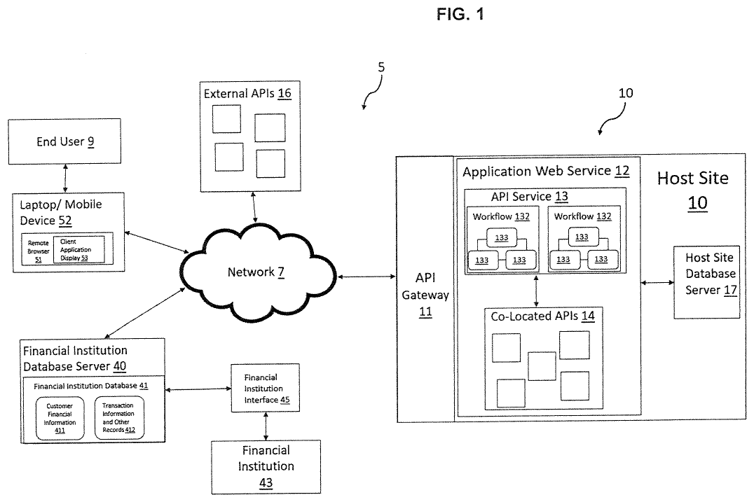

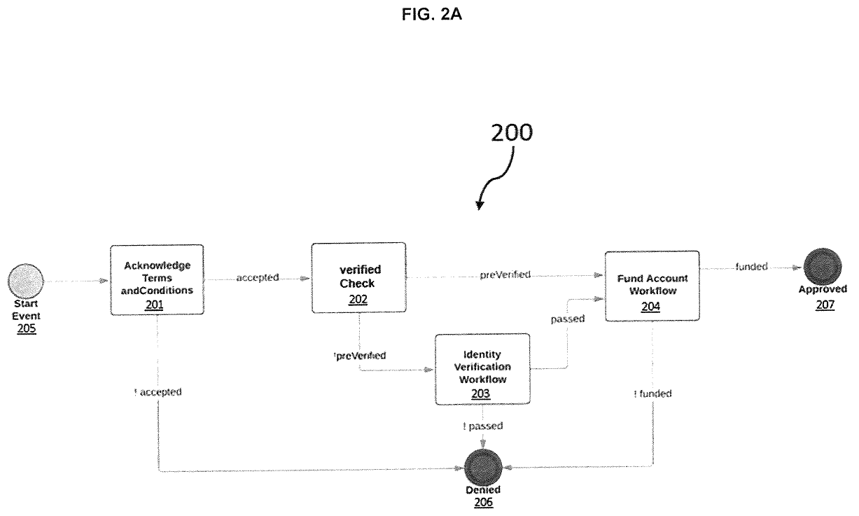

Referring to FIG. 1, a block diagram of an API-driven internet financial services system 5 is shown in accordance with an illustrative embodiment. In FIG. 1, blocks with square corners refer to services, while blocks with rounded corners refer to data structures, and double-sided arrows between structures indicate that data may be exchanged between two connected structures. API-driven internet financial services system 5 includes a host site 10 including an API gateway 11 and an application web service 12. The application web service 12 includes at least one API service 13 running an API (not pictured) and including workflow items 131. The workflow items 131 include at least one workflow 132 characterized by a workflow definition (not pictured) and at least one workflow task 133 characterized by a workflow task definition (not pictured). Each of the workflow items is defined according to JSON and JSON schema. The internet financial services system 5, so defined, integrates with external APIs 16 and co-located APIs 14 directly, the co-located APIs 14 located within the application web service 12 and the external APIs located external to the host site 10 and accessible from the API service through the network 7, without marshalling of financial institution code for external or co-located API 16, 14 communication to allow flexible, financial institution-customizable internet financial services for an end user 9. Host site 10 may further include host site database server 17, which may store data associated with the functioning of API service 13 or co-located APIs 14.

In embodiments, the internet financial services system 5 may further include a financial institution database server 40 including a financial institution database 41. The financial institution database 41 may include customer financial information 411 and transaction information and other records 412. The internet financial services system allows for an end user 9 with access to a network 7 to remotely communicate, exchange/interchange data, and perform other interactions via a remote client (e.g., a browser) 51 on a laptop, mobile, or other device 52 working on a client application display 53 thereon with the financial institution database 41. A financial institution 43 can interact with and manage financial institution database server 40 and financial institution database 41 thereon via financial institution interface 45. In the embodiment shown in FIG. 1, internet financial services and interactions between end user 9 and financial institution are mediated and provided using API service 13.

Network 7 may include one or more networks of the same or different types. Network 7 can be any type of wired and/or wireless public or private network including a cellular network, a local area network, a wide area network such as the internet, etc. Network 7 further may include sub-networks and consist of any number of devices.

The components of internet financial services system 5 may be included in a single computing device, located in a single room, in a single facility, and/or may be distributed geographically from one another.

According to certain embodiments, workflow items use a uniform representation including an execution state, a set of local data described by JSON schema, and an interface described by JSON schema. The local data resides in the API service, though it may interact with other components or be changed by operation of the API service. The interface may define a set of possible inputs and outputs, wherein the possible inputs and outputs are a subset of the local data. A workflow's initial execution state, local data, workflow tasks, and interface are dictated by its corresponding workflow definition. Each workflow is characterized and ordered by a dependency and execution sequence graph according to the workflow definition. Such a dependency and execution sequence graph consists of connecting the inputs and outputs of each workflow task of the workflow to the inputs and outputs of other workflow tasks and/or to data of the workflow. In this way, a workflow definition provides a template for each workflow instantiated therefrom. The workflow's initial execution state and local data can then be changed by operation of the workflow without having an effect on the workflow definition. Any workflow task's initial execution state, local data, and interface are dictated by the workflow task's corresponding workflow task definition.

In preferred embodiments, any workflow and its execution state, interface, workflow tasks, and local data can be saved as a new workflow definition and any workflow task and its execution state, interface, and local data can be saved as a new workflow task definition. In this way, workflows and workflow tasks can be easily revised and reworked by calling on saved workflow definitions and saved workflow task definitions in the API environment without the need for marshalling of code with the implementation of updates. Additionally, by virtue of local data being described according to JSON schema, data that flows through a workflow represents high level business domain objects such as users, account applications, documents, approvals, accounts, transfers, and so on. Data so defined enables easy intercommunication between APIs and use or modification by system managers at the API level.

In certain embodiments, the interface of a workflow item defines allowable inputs and outputs, which are a subset of the local data for that workflow item. The inputs and outputs are values that may be connected to other inputs and outputs of other workflow items to define the flow of data through a workflow or workflows. Inputs describe data values that may be passed into a workflow item in order for it to act on or process that input data each time the workflow item executes. Some inputs may be marked as “required”: they must be provided for the workflow item to run. In other words, the input data value must be connected to a data value in the containing workflow item or to the output of another, dependent workflow item. Outputs describe data values that the workflow item generates or computes, to be used by subsequent workflow items that depend on the workflow item.

In certain embodiments, workflow items further include a values object to hold local data. Data flows between workflows and/or workflow tasks. Each value in each workflow item's values object has a name that is unique within its respective values object. Each data value also has a data type, such as number, character string, Boolean, or array or object types. These data names and types are defined and constrained using JSON schema, for example Internet Engineering Task Force (IETF) standard JSON Schema.

In certain embodiments, workflow items maintain a current execution state. The current execution state may be the same or different from an initial execution state imparted from a corresponding workflow item definition in the instantiation of the workflow item from the workflow item definition. In some embodiments, current execution state may for example be: 1) “blocked” because dependent tasks have not completed; 2) “pending” if input constraints are satisfied, but the workflow item has to be started via interaction; 3) “running” which means a workflow item is processing inputs or waiting for an event or trigger to complete; 4) “paused” which means the workflow item is suspended, awaiting a request to resume; 5) “failed” if an error occurred; 6) “canceled” if the end user canceled the workflow item; or 7) “completed” if the workflow item finished without error. Based on these workflow item execution state values, the workflow can also convey a representation of blocked, pending, running, paused, failed, canceled, and completed tasks. In certain embodiments, this representation may be generated from a hierarchical list, where nested workflow items are represented in the client application as nested sublists. Itemization of pending vs. blocked vs. running vs. paused vs. failed vs. canceled vs. completed tasks allow the application to inform an end user of their progress through a workflow (e.g., 25% complete, 80% complete, 100% complete).

In certain preferred embodiments, each workflow definition and each workflow task definition is immutable in the context of workflow operation and may be used to instantiate new workflow items via reference in a separate workflow item to a workflow definition name or a workflow task definition name representing the respective workflow definition or workflow task definition. For example, a first workflow may call on or reference, for example by hyperlink reference, a second workflow to be accomplished as a workflow task of the first workflow. By immutable, it is meant here that the workflow item definitions may not be changed by an end user's interaction with the system or a workflow's regular execution. The first workflow call and execution of the second workflow does not change the workflow definition of the second workflow, though the particular instance of the second workflow is mutable and may be changed by operation of the first or second workflows. Similarly, a first workflow task of a third workflow may reference, for example by hyperlink reference, a second workflow task from the third or a different workflow for execution in the third workflow. The first workflow task call and execution of the second workflow task does not change the workflow task definition of the second workflow task, though the particular instance of the second workflow task is mutable and may be changed by operation of the third workflow. Thus, a workflow definition or workflow task definition need not be copied in its entirety each time it is reused-only the reference need be specified. By the same token, changes made to a workflow definition or a workflow task definition are automatically reflected in all new workflow item instances that reference the changed workflow item definition.

In certain embodiments, instead of allowing editing and updating of workflow item definitions by a system manager only with respect to a latest default revision of each workflow item definition, the API service of the internet financial services system allows a system manager to create a revision of a workflow item definition that contains changes. In certain embodiments, when a workflow item references another workflow item name corresponding with an altered workflow definition revision, it can reference a specific revision of the other workflow item name by a revision identifier of the other workflow item name or it can reference the other workflow item by name without a revision identifier, in which case the workflow item references the latest revision of the other workflow item when the workflow item is instantiated from its workflow item definition.

In certain embodiments, workflow items are embedded or referenced in new or other workflow items as hypermedia controls with a link representing a relationship from the new or other workflow item to the embedded or referenced workflow item. Operations may also be accomplished by hypermedia controls. A link (analogous to a link on a web page) represents a relationship from one resource to another, or it may represent an action to be performed on a resource. For instance: an account application resource has a (hypermedia) link to a workflow that executes a process for completing an account application for a specific banking product; a workflow item has a link to a workflow item definition from which the workflow item is instantiated; workflow items have links to operations, such as a link to start a pending workflow, a link to suspend a workflow item, a link to resume a suspended workflow item, or a link to cancel a task or workflow.

In certain preferred embodiments, the internet financial services system includes at least one workflow task that supports calling an external REST API that is external to a host site in which the internet financial services system API service resides or that is co-located within the host site. Workflow tasks call external REST APIs or co-located REST APIs by using the appropriate REST call verb and having an API-compatible interface. In this manner, the internet financial services system may allow further integration with the external or co-located API environment absent code martialing.

In certain embodiments, workflows, workflow tasks, and data embodied therein have persistence. Typically, and as generally contemplated herein, persistence of workflow items and data embodied therein refers to maintenance of the execution states and data values of a workflow and its workflow tasks with respect to a particular instance of a workflow definition. Because workflows may involve external human interaction such as manual review of a user's documents by a human agent, it may be beneficial for the system to persist the state of the workflow and its tasks to allow for such a review external to the system before the workflow proceeds. Persistence allows the user to leave and then come back to the workflow without starting over following a human agent's (or artificial intelligence's) review or intervention. For a RESTful API, the persistence mechanism (a database or other long-term storage mechanism) is encapsulated within the API service. By this it is meant that the internet financial services system manager or other agent of a financial services provider does not actively manage the persistence. The database or other persistence mechanism can be physically external to but accessible and/or co-located with the API service, as is the case with API service 13 and host site database server 17 of the internet financial service system 5, shown in FIG. 1. In the case of such persistence, the internet financial services system manager simply refers to resources through uniform resource identifiers, or URIs. This also allows an end user to start a workflow on one device (a web interface in a rich browser) and resume the workflow on another device (a mobile phone or tablet experience), switching between platforms at will. This also allows workflows to be resilient to connection failures or faulty clients.

In certain embodiments, workflow items may further have “attributes”, which are certain characteristics associated with a particular instance of a workflow or workflow task relating to state of the workflow or workflow task and are stored as local data.

According to certain embodiments, and in some applications, some workflow items may be defined to not be restartable or reversible as required to support a business rule. For example, it may be desirable to limit completion of a particular workflow or workflow task to a particular time period and allowable number of incorrect attempts to prevent or discourage fraudulent use. In embodiments, workflow tasks may include a “restartable” attribute that determines, through execution by an execution engine of a workflow containing the workflow task, whether the workflow task may be restarted or not. For example, a workflow task for uploading identity verification documents may be provided with a restartable attribute that allows the workflow task for uploading identity verification documents to be restarted when certain conditions in a corresponding workflow (i.e., conditions to reduce the risk of fraud) are met. A workflow task may analogously include a “not restartable” attribute.

In certain embodiments, workflow items may have the attributes “visible” or “not visible” (“not visible” is equivalently referred to herein as “hidden”). End user interfaces and applications show only visible tasks to the end user in the client application. The end user is not aware of workflow items that are not visible.

In certain embodiments, workflow items may be interactive which means the client application must allow the end user to interact with the workflow item. Such workflow items may be made interactive by having an “interactive” attribute. Examples of workflow tasks that might be made interactive include but are not limited to: 1) answer a yes/no question; 2) complete and submit a form, such as the name and address of a co-owner; 3) upload one or more documents; 4) consent to the terms and conditions or other policy document; or 5) choose one or more values from a list.

In certain embodiments, workflow tasks further include a task type which determines the nature of the processing the API service does for all workflow tasks that have that type. If the workflow task is interactive, the task type also determines the nature of the processing the client and/or end user must perform for a workflow task of that type.

The following non-exclusive list provides exemplary task types for online financial services applications with verbal descriptions of the task types, though further task types will be discernable to persons of ordinary skill in the art in light of this disclosure. “approvalReview”—A hidden, non-interactive task. Represents the work for a financial institution operator to manually review a bank customer's application to open a new account at the financial institution. The operator reviews all the information supplied by the customer and information obtained by risk and identity verification services to make a decision to accept or reject the application or to return the application to the customer to supply additional information before rendering final decision. “uploadDocument”—A visible, interactive task. The client asks the end user to capture or upload a photograph or scanned image of an identification document, such as a government issued ID card, to verify they are who they claim to be. This task type may be used conditionally if other risk factors already calculated indicate elevated risk, such as a customer who has not verifiably lived at their current address for more than two years, or a customer whose data does not match other historical identity verification data. This type of task can also be used to allow the applicant for a business account to upload business documents such as the business' articles of incorporation. Such documents provide data for operators reviewing account applications for the above approvalReview tasks. “start”—A hidden, non-interactive task type. Indicates the first or “start” task in a larger workflow consisting of many tasks. “form”—A visible, interactive task. Represents a form or other data collection user interface to prompt the user to supply multiple related data fields, such as their name, date of birth, address, and other identifying information. Each form task can collect different types of data, as determined by a form template or a JSON schema that describes the data to be collected. “workflow”—A hidden, non-interactive task. Represents a nested sub-workflow of the containing workflow. This task type allows financial institutions or system managers the ability to modularize many larger workflows by breaking them down into smaller composable, reusable workflows. For example, a complex multi-task workflow to specify how to fund a new banking account from some other financial instrument can be defined as a single workflow. Then, that funding workflow can be included in larger workflows (such as a workflow to open a new account), which needs to reuse the capability of funding a new account. “openAccount”—A hidden non-interactive task type. Processes a completed and approved new account application and creates the financial account within the financial institution's core banking provider, and associates the applicant with the account. “acknowledge”—A visible, interactive task. Presents to the bank customer acknowledgement of successful completion of a workflow activity, such as opening an account, and may present key information to the customer, such as the account number, where the account is funded, and the terms of the account such as its annual percentage rate. “end”—A hidden, non-interactive task. Marks completion of a workflow. An end task is a terminal task. Once a terminal task is processed, the workflow execution ends and the workflow state is marked as completed or failed, depending on the attributes of the end task. A workflow may have multiple successful end tasks and multiple failure end tasks.

In certain embodiments, workflow tasks further include a data conversion expression allowing transformation of input data of the workflow task as part of the workflow task operation as opposed to in a separate transformation step in the corresponding workflow definition.

In further embodiments, this disclosure provides a non-transitory computer-readable storage medium including instructions for implementing an internet financial services system according to any embodiment disclosed herein.

The examples that follow are intended to illustrate certain instances and uses of the presently described invention, but are not intended to be limiting in any way.

### Example 1

Example 1 illustrates an embodiment of the above-described internet financial services system with application to a workflow definition for use in an internet financial services system according to the present invention. In particular, the workflow definition of Example 1 provides a business flow for opening a new bank account via a self-service client application running in a web browser.

The Example 1 process provides for the following possible workflow tasks, each provided with a task reference name, which allows programmatic access to the tasks, a task type, which determines the nature of the processing conducted for the corresponding workflow task, and a brief, verbal description of the respective workflow task functions in Table 1, below:

TABLE 1

| Workflow Task | | |
|---|---|---|
| Name (Task | | |
| Reference Name) | Task Type | Verbal Task Summary |
| start | start | A Start task which marks the beginning of the |
| | | workflow (start). Each workflow requires at least |
| | | one Start task. |
| acceptTAndC | consent | Accept Terms and Conditions requires the bank |
| | | customer to accept the terms and conditions of the |
| | | bank account and electronic use consent, giving the |
| | | financial institution permission to conduct banking |
| | | using on-line applications |
| VerifiedCheck | preVerifiedCheck | Identity Pre-Verified securely checks if the user has |
| | | already verified their identity |
| idVerification | identityVerification | Identity Verification Workflow task to require the |
| | | bank customer to prove they are who they claim to |
| | | be and allow the financial institution to verify that the |
| | | person's identity is not associated with fraud, |
| | | government watch lists, etc. In the Example |
| | | workflow, the Identify Verification Workflow task |
| | | calls a separate workflow that accomplishes identify |
| | | verification. |
| fundAccount | fundAccount | Fund Account Workflow task to allow the user to |
| | | fund the new account by identifying an external |
| | | account that they own and scheduling a transfer of |
| | | funds into the new account to meet the initial |
| | | account balance requirements. In the Example |
| | | workflow, the Fund Account Workflow task calls a |
| | | separate workflow that accomplishes account |
| | | funding. |
| denied | end | To indicate a digital bank application is denied. This |
| | | is an end or terminal task that marks the end of a |
| | | workflow. At least one end task is required for each |
| | | workflow according to this Example. |
| approved | end | To indicate a digital bank application is approved. |
| | | This is an end or terminal task that marks the end of |
| | | a workflow. At least one end task is required for |
| | | each workflow according to this Example. |

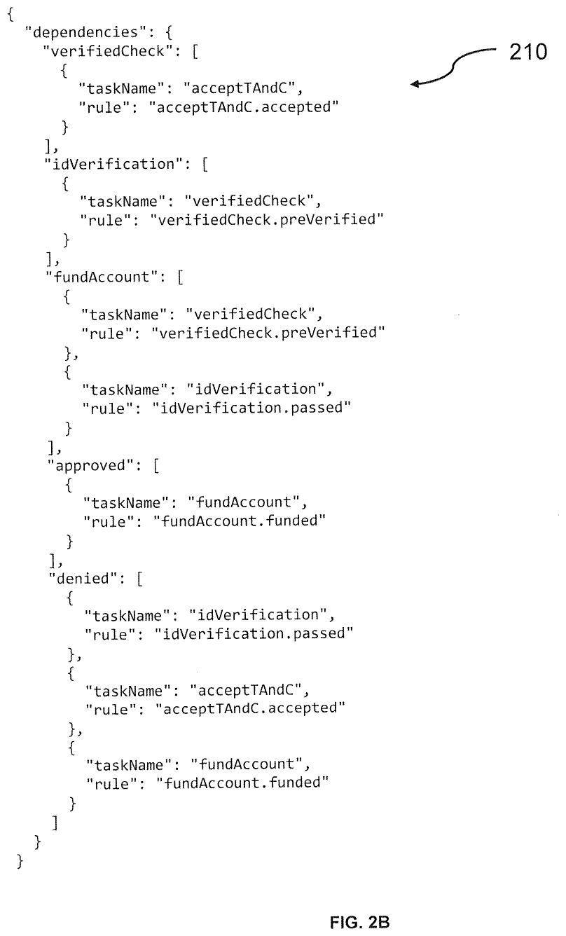

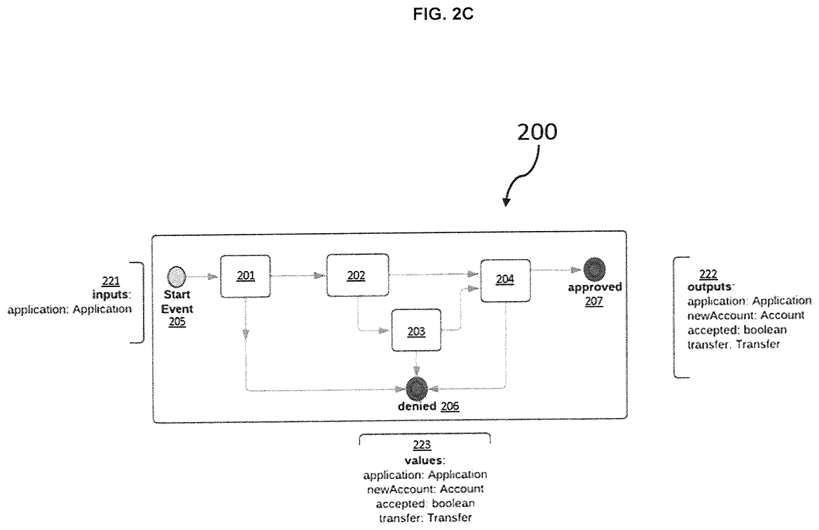

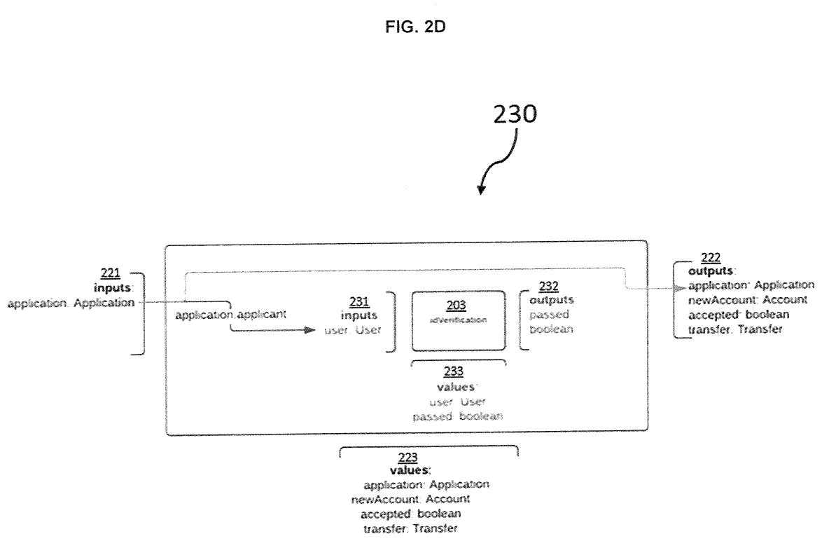

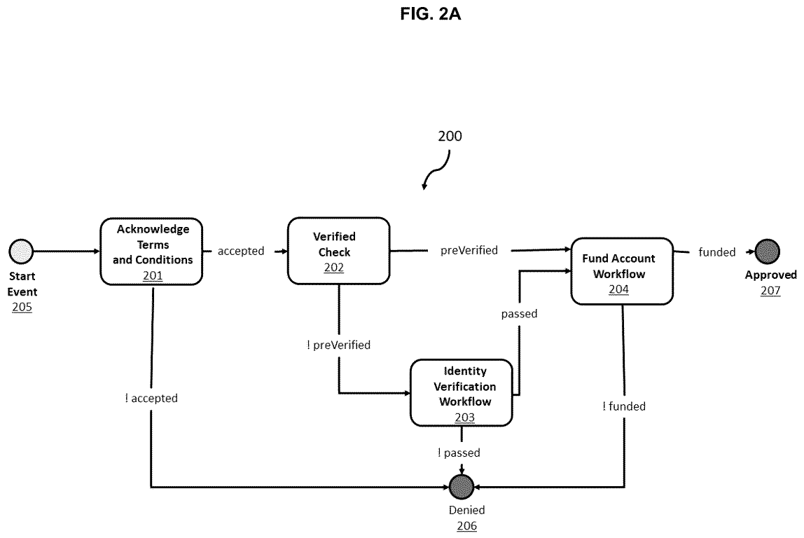

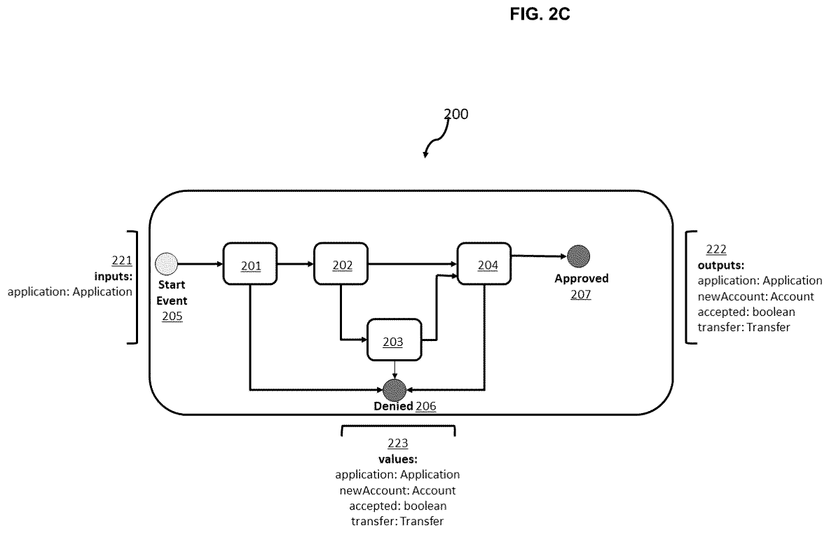

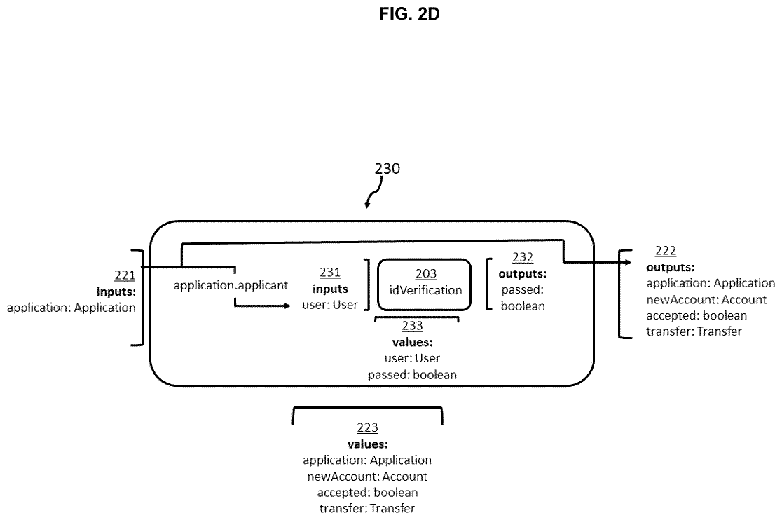

A workflow definition for the Example 1 process is subject to the following dependencies, described verbally herein, for connecting workflow tasks via direct dependencies or optional business rules in a dependency graph 200 as shown in FIG. 2A. The acceptTandC workflow task 201 starts following the start workflow task 205, which runs automatically upon workflow startup. The VerifiedCheck workflow task 202 executes after acceptTandC 201, if that workflow task has a true value for an “accepted” data value. The idVerification workflow task 203 does not start unless the VerifiedCheck workflow task 202 completes with a “preVerified” value that has the value false. This value is used in the Boolean expression !verifiedCheck.preVerified which represents the negation of the value named “preVerified” in the verifiedCheck task. Thus, the idVerification workflow task 203 only executes if the user has not already been pre-verified. The idVerification workflow task 203 calls a separate workflow to accomplish identity verification. The fundAccount workflow task 204 starts when either the verifiedCheck workflow task 202 completes with a “preVerified” value equal to true or the idVerification workflow task 203 completes and has a value “passed” which has the value true. The fundAccount workflow task 204 executes a separate workflow (not shown) to accomplish account funding. According to the workflow definition, the workflow completes in the terminal approved task 207 if the other tasks before it complete and the value “funded” of the fundAccount task 204 is true. The workflow completes in the terminal denied task 206 if identity verification is completed and the value “passed” is false (that is, the negation “!passed” has the value true), the acceptTandC workflow task 201 is completed and the value “passed” in the idVerification task 203 is not true, or if the other two tasks fail.

In the workflow definition, these dependencies and business rules are structurally defined by JSON data structures in a dependencies array 210 as shown in FIG. 2B. The dependencies array 210 establishes the dependent workflow task or tasks for each workflow task and an optional business rule which must be true for that workflow task to execute when one or more of its dependent workflow tasks complete. For example, acceptTAndC 201 depends on the completion of the start task 205 (with no additional business rule), and the VerifiedCheck 202 and denied 206 tasks depend on the acceptTAndC task 201.

The default business rule, if no rule is defined for a first task, checks that at least one of the first task's dependent tasks has finished. When any task completes, all tasks which depend on it evaluate their business rules and if the rule evaluation result is true, the depending task(s) execute.

The workflow definition of the Example 1 system provides that the workflow local data includes four data fields as described in Table 2:

TABLE 2

| Data Field and Contents | Verbal Description of Data Field Contents |
|---|---|
| application: Application | // represents the user's application to |
| | open a new account |
| | // this object contains nested data, such as the |
| | applicant, the type of account to open, etc. |
| newAccount: Account | // represents the new account created by this |
| | workflow |
| accepted: boolean | // indicates if the user accepted the terms and |
| | conditions |
| transfer: Transfer | // represents a transfer to initially fund the new |
| | account |

In Example 1, local data associated with a workflow item may be supplied as an input or an output from a previous task according to JSON schema or may be supplied from other REST APIs. For example, a separate REST API for managing new account applications may have an API call to create a new application resource:
POST https://api.example.com/accountApplications/applications

This operation returns a JSON response that is defined with the application JSON schema as generally described in Table 2. Thus, the output of the API call is passed directly to the workflow input field, application. Similarly, when the fundAccount workflow task (see Table 1) executes, its output data value, a transfer as described in Table 2, may be defined with the JSON responses from another REST API call that creates a transfer:
POST https://api.example.com/transfers/scheduledTransfers
   The resulting value can be bound to the transfer field of the workflow task's data values object.

In the workflow definition of Example 1, the application local data value is an input and all four local data values (application, newAccount, accepted, transfer) are the outputs. FIG. 2C shows the example workflow definition represented as a dependency and execution sequence graph 200 associated with the example workflow definition with inputs 221, outputs 222, and data values 223 shown relative to their conceptual position in the dependency and execution sequence graph 200.

In Example 1, workflow task definitions similarly define workflow task local data having structures that follow JSON schema. FIG. 2D shows a graphical representation of the exemplary idVerification workflow task definition 230 (for the idVerification workflow task 203) with inputs 231, outputs 232, and data values 233 shown relative to their conceptual position in the diagram. The workflow task definition 230 is shown conceptually as part of a workflow definition having dependency and execution sequence graph 200 (contents omitted from FIG. 2D) with the inputs 221, outputs 222, and data values 223 of the workflow definition also shown. Arrows and flow lines show the logic of the flow through the workflow task defined by workflow task definition 230.

### Example 2

Example 2 provides a high-level, skeletal definition of resource paths and operations of a RESTful API service for managing workflow definitions, workflow tasks, and workflow execution. Notation is presented in a condensed version relative to that defined by the OpenAPI 2.0 specification. The below resource paths and operations provide various useful resources for management of an API-driven internet financial services system. One having ordinary skill in the art will understand that many implementations of the invention can be realized from this resource list, and still further implementations can be realized with additional resources in the character of those resources provided below.

```
/tasks:
  get:
    summary: Return a collection of tasks
    responses:
      200:
        schema: tasks
  post:
    summary: Create a new task
    parameters:
      - in: body
        schema: createTask
    responses:
      201:
        schema: task
/tasks/{taskId}:
  get:
    summary: Fetch a representation of this task
    responses:
      200:
        schema: task
  put:
    summary: Update this task
    parameters:
      - in: body
        schema: task
    responses:
      200:
        schema: task
  delete:
    summary: Delete this task resource
/tasks/{taskId}/values:
  get:
    summary: Fetch the runtime values associated with this task
    responses:
      200:
        schema: attributes
  put:
    summary: Update the runtime values associated with this task
    parameters:
      - in: body
        schema: attributes
    responses:
      200:
        schema: attributes
/tasks/{taskId}/values/{valueName}:
  get:
    summary: Fetch a single runtime value associated with this task
    responses:
      200:
        schema:
          type: object
  put:
    summary: Update the runtime values associated with this task
    parameters:
      - name: values
        in: body
        schema: attributes
    responses:
      200:
        schema: attributes
/runningTasks:
  post:
    summary: ‘Start, restart, or resume a workflow task’
    responses:
      200:
        schema: task
/pausedTasks:
  post:
    summary: Pause a workflow task
    responses:
      200:
        schema: task
/canceledTasks:
  post:
    summary: Cancel a workflow task
    responses:
      200:
        schema: task
/failedTasks:
  post:
    summary: Stop a workflow task and mark it as failed
    responses:
      200:
        schema: task
/taskDefinitions:
  get:
    summary: Return a collection of task definitions
    responses:
      200:
        schema: tasks
  post:
    summary: Create a new task definition
    parameters:
      - in: body
        schema: createTask
    responses:
      201:
        schema: task
/taskDefinitions/{taskDefinitionId}:
  get:
    summary: Fetch a representation of this task definition
    responses:
      200:
        schema: task
  put:
    summary: Update this task definition
    parameters:
      - in: body
        schema: task
    responses:
      200:
        schema: task
  patch:
    summary: Update this task definition
    parameters:
      - in: body
        schema: task
    responses:
      200:
        schema: task
  delete:
    summary: Delete this task definition resource
/taskDefinitions/{taskDefinitionId}/revisions:
  get:
    summary: Return a collection of workflow task definition revisions
    responses:
      200:
        schema: tasks
  post:
    summary: Create a new task definition revision
    responses:
      201:
        schema: task
      204: { }
/taskDefinitions/{taskDefinitionId}/revisions/{revisionId}:
  get:
    summary: Fetch a representation of an immutable revision of this workflow
task
    responses:
      200:
        schema: task
/workflows:
  get:
    summary: Return a collection of workflows
    responses:
      200:
        schema: workflows
  post:
    summary: Create a new workflow
    parameters:
      - name: workflow
        in: body
        schema: createWorkflow
    responses:
      201:
        schema: workflow
/workflows/{workflowId}:
  get:
    summary: Fetch a representation of this workflow
    responses:
      200:
        schema: workflow
  delete:
    summary: Delete this workflow resource
/workflows/{workflowId}/visibleTasks:
  get:
    summary: >−
      Fetch an ordered representation of the visible tasks within this
      workflow
    responses:
      200:
        schema: visibleTasks
/workflows/{workflowId}/values:
  get:
    summary: Fetch the runtime values associated with this workflow
    responses:
      200:
        schema:
          type: object
  put:
    summary: Update the runtime values associated with this workflow
    parameters:
      - in: body
        schema: attributes
    responses:
      200:
        schema: attributes
/workflows/{workflowId}/values/{valueName}:
  get:
    summary: Fetch a single runtime value associated with this workflow
    responses:
      200:
        schema: attributes
  put:
    summary: Update a single runtime value associated with this workflow
    parameters:
      - in: body
        schema: attributes
    responses:
      200:
        schema: attributes
/runningWorkflows:
  post:
    summary: ‘Start, restart, or resume a workflow’
    responses:
      200:
        schema: workflow
/pausedWorkflows:
  post:
    summary: Pause a workflow
    responses:
      200:
        schema: workflow
/canceledWorkflows:
  post:
    summary: Cancel a workflow
    responses:
      200:
        schema: workflow
/failedWorkflows:
  post:
    summary: Stop a workflow and mark it as failed
    responses:
      200:
        schema: workflow
/workflowDefinitions:
  get:
    summary: Return a collection of workflow definitions
    responses:
      200:
        schema: workflows
  post:
    summary: Create a new workflow definition
    parameters:
      - in: body
        schema: createWorkflow
    responses:
      201:
        schema: workflow
/workflowDefinitions/{workflowDefinitionId}:
  get:
    summary: Fetch a representation of this workflow definition
    responses:
      200:
        schema: workflow
  put:
    summary: Update this workflow definition
    parameters:
      - name: workflowDefinition
        in: body
        schema: workflow
    responses:
      200:
        schema: workflow
  patch:
    summary: Update this workflow definition
    parameters:
      - in: body
        schema: workflow
    responses:
      200:
        schema: workflow
  delete:
    summary: Delete this workflow definition resource
/workflowDefinitions/{workflowDefinitionId}/revisions:
  get:
    summary: Return a collection of workflow definition revisions
    responses:
      200:
        schema: workflows
  post:
    summary: Create a new workflow definition revision
    responses:
      201:
        schema: workflow
      204: { }
/workflowDefinitions/{workflowDefinitionId}/revisions/{revisionId}:
  get:
    summary: >−
      Fetch a representation of an immutable revision of this workflow
      definition
    responses:
      200:
        schema: workflow
```

It should be appreciated that, in the above description of embodiments, various features are sometimes grouped together in a single embodiment, figure, or description for the purpose of streamlining the disclosure and aiding in the understanding of one or more of the various inventive aspects. This method of disclosure, however, is not be interpreted as reflecting an intention that any claim requires more features than are expressly recited in that claim. Moreover, any components, features, or steps illustrated and/or described in a particular embodiment herein, can be applied to or used with any other embodiment. Thus, it is intended that the scope of the inventions herein disclosed should not be limited by the particular embodiments described above, but should be determined only by a fair reading of the claims that may issue from the benefit of the within disclosure.

We claim as follows:

1. An institution-customizable internet financial services system, the system comprising:
a host site that includes:
an application web service, the application web service comprising an application programming interface (API) service wherein the API service comprises workflow items having:
at least one workflow characterized by a workflow definition, and
at least one workflow task characterized by a workflow task definition and wherein all workflows include at least one workflow task;
wherein the workflow items follow JavaScript Object Notation (JSON) JSON and JSON schema, cause the system to perform the operations of:
receiving the workflow input selection and a workflow task input selection from an interface;
identifying the workflow definition associated with the workflow selection and the workflow task definition associated with the workflow task;
retrieving an execution sequence graph template according to the workflow definition and an execution sequence graph template according to the workflow task definition; and
revising a workflow initial execution state and a workflow task initial execution state;
wherein the revising a section of workflow calls on saved workflow definitions and saved workflow task definitions in the API environment; and
wherein a code for the workflow definition and a code for the workflow definition does not need to be marshaled into API-friendly formats during the revising.

2. The internet financial services system of claim 1, wherein the host site further includes an API gateway and an API.

3. The internet financial services system of claim 1, further including a database server with an internet financial services database.

4. The internet financial services system of claim 1, wherein each workflow definition includes a dependency and execution sequence graph including workflow tasks, wherein execution of the workflow tasks is coordinated according to the workflow definition as provided in the dependency and execution sequence graph.

5. The internet financial services system of claim 1, wherein the workflow items use a uniform representation include an execution state, a set of local data described by JSON schema, and an interface.

6. The internet financial services system of claim 5, wherein the workflow item interface defines a set of inputs and outputs consisting of a subset of the local data.

7. The internet financial services system of claim 6, wherein any workflow task, its interface and local data, or derivatives thereof, can be saved as a new workflow task definition and any workflow, its interface and local data, or derivatives thereof, can be saved as a new workflow definition.

8. The internet financial services system of claim 1 wherein each workflow definition includes a dependency and execution sequence graph and wherein the dependency and execution sequence graph of each workflow definition includes workflow tasks connected to one another by their respective inputs and outputs in a designated sequence.

9. The internet financial services system of claim 1, wherein at least one workflow task supports calling a REST API that is external to the host site or is co-located with the API service in the host site.

10. The internet financial services system of claim 1, wherein the workflow item definitions are immutable and may be included in new or other workflow items by reference.

11. The internet financial services system of claim 10, wherein the workflow items are embedded in new or other workflow items as hypermedia controls with a link representing a relationship from the new or other workflow item to the referenced workflow item.

12. The internet financial services system of claim 1, wherein the workflow items are persistent.

13. The internet financial services system of claim 1, wherein each workflow definition and workflow task definition is immutable to a system manager and instead of being edited or updated, workflow definitions and workflow task definitions are changed by creating new revisions that contain changes, said new revisions can be referenced in a workflow item by a workflow item title containing a name of the workflow item and revision identifier, or a workflow item can reference the latest revision of a workflow by referencing only a name of the workflow item, absent a revision identifier.

14. The internet financial services system of claim 1, wherein an end user accesses the internet financial services system to conduct an internet financial services transaction by connecting to the host site and API service using a browser from a remote client.

15. The internet financial services system of claim 14, wherein a link between the remote site and the host site is secured through the use of Hypertext Transfer Protocol or a virtual private network.

16. The internet financial services system of claim 1, wherein the workflow tasks further include a restartable attribute that determines, according to execution by an execution engine of a workflow containing the workflow task, whether the workflow task may be restarted or not.

17. A computer-implemented method for performing internet financial services with a financial institution-customizable internet financial services platform, the method comprising:
providing an application program interface (API) service, wherein the API service resides in an application web service accessible through a network to allow communication between an end user and a financial services institution via the API service, wherein the API service resides in an application web service accessible through a network;
wherein the API service includes workflow items having at least one workflow and at least one workflow task, and wherein all workflows include at least one workflow task;
receiving at least one workflow selection is characterized by a workflow definition, and at least one workflow task selection is characterized by a workflow task definition and wherein all workflows include at least one workflow task;
wherein the workflow items follow JavaScript Object Notation (JSON) and JSON schema;
identifying the workflow definition associated with the workflow selection and the workflow task definition associated with the workflow task;
retrieving an execution sequence graph template according to the workflow definition and an execution sequence graph template according to the workflow task definition; and
revising a workflow initial execution state and a workflow task initial execution state;
wherein the revising a section of workflow calls on saved workflow definitions and saved workflow task definitions in the API environment; and
wherein a code for the workflow definition and a code for the workflow definition does not need to be marshaled into API-friendly formats during the revising.

18. The computer-implemented method of claim 17, further including:
using a uniform representation for the workflow items that have an execution state, a set of local data, and an interface;
defining a set of inputs and outputs that are each a subset of the local data, and the inputs and outputs are each defined according to JavaScript Object Notation (JSON) and JSON schema;
saving any workflow item and local data as a new workflow item definition, wherein the workflow item definitions are immutable and may be included in new or other workflow items by reference;
wherein at least one workflow task supports calling a REST API that is external to the application web service;
performing high-level business (financial services) processes; and
wherein each workflow item is immutable and instead of being edited or updated, changing workflow items by creating new revisions that contain changes, said revisions referenced in a workflow item by a workflow item title containing a name of the workflow item and revision reference number, or a client can reference the latest revision of a workflow by referencing only the name of the workflow item, absent a revision reference number.

19. A non-transitory computer-readable storage medium having instructions, wherein the instructions cause a processor to perform steps comprising:
accessing an application programming interface API service, the API service residing in an application web service that may be accessed through a network to allow communication between an end user and a financial services institution via the API service;
wherein the API service has workflow items with at least one workflow and at least one workflow task, and wherein all workflows include at least one workflow task;
wherein the at least one workflow is characterized by a workflow definition, and the at least one workflow task is characterized by a workflow task definition;
wherein the workflow items follow JavaScript Object Notation (JSON) and JSON schema;
receiving a workflow input selection and a workflow task input selection from an interface;
identifying the workflow definition associated with the workflow selection and the workflow task definition associated with the workflow task;
retrieving an execution sequence graph template according to the workflow definition and an execution sequence graph template according to the workflow task definition;
revising a workflow initial execution state and a workflow task initial execution state;
wherein the revising a section of workflow calls on saved workflow definitions and saved workflow task definitions in the API environment;
wherein a code for the workflow definition and a code for the workflow definition does not need to be marshaled into API-friendly formats during the revising.

20. The non-transitory computer-readable storage medium of claim 19, wherein the steps further include:
using a uniform representation for the workflow items with an execution state, a set of local data, and an interface;
defining a set of inputs and outputs that are each a subset of the local data, and the inputs and outputs are each defined according to JSON and JSON schema;
saving any workflow item and its interface and local data as a new workflow item definition and the workflow item definitions are immutable and may be included in new or other workflow items by reference;
wherein at least one workflow task supports calling a REST API that is external to the application web service;
wherein the workflow tasks performing high-level business (financial services) processes; and
wherein each workflow item is immutable and instead of being edited or updated, workflow items are changed by creating new revisions that contain changes, said revisions can be referenced in a workflow item by a workflow item title containing a name of the workflow item and revision reference number, or a client can reference the latest revision of a workflow item by referencing only the name of the workflow item, absent a revision reference number.
